(19) United States
(12) Patent Application Publication
(10) Pub. No.: US 2016/0329758 A1
(43) Pub. Date: Nov. 10, 2016

(54) MAGNETICALLY ISOLATED ELECTRICAL MACHINES

(71) Applicant: QM Power, Inc., Kansas City, MO (US)

(72) Inventors: Charles J. Flynn, Greenwood, MO (US); Steve Nichols, Lee's Summit, MO (US)

(21) Appl. No.: 14/707,054

(22) Filed: May 8, 2015

(51) Int. Cl. H02K 1/16; H02K 21/14; H02K 1/27

(52) U.S. Cl. CPC H02K 1/165; H02K 1/2753; H02K 21/14

(57) ABSTRACT

The invention discloses an isolated phase IPM (interior permanent magnet) machine having alternating opposite permanent magnetic poles and a stator with one less number of teeth than the rotor poles. The stator teeth are of uniform width in the radial direction and are separated by stator slots of uniform width. The slots accommodate concentrated armature coils surrounding the teeth and forming a plurality of electrical phase groups. In one embodiment all the teeth are of the same width.

### FIELD OF THE INVENTION

The disclosure relates generally to an isolated phase interior permanent magnet machines with fewer stator teeth that are also uniform, thereby reducing cogging torque, mechanical vibrations, and acoustic noise.

### DESCRIPTION OF THE RELATED ART

With few exceptions, the basic operating principles for electric motors and generators have not changed much over the past 100 years. With the development of high energy or high coercive force permanent magnets the power density and efficiency of electric motors were increased over the then state of the art motor technologies by replacing the field coils in brush motors or armature coils in brushless motors with permanent magnets. The permanent magnets require less space and typically weigh less than the copper windings they replaced and reduce the I²R losses of the motor's total electrical system.

In a conventional permanent magnet (PM) rotating machine having a rotor and stator, rotor magnets normally are mounted on the surface of the rotor back iron and produce an air gap flux density equal to the area of one of the permanent magnet's pole face area, as reduced by the air gap reluctance. Further, the magnets are located on the rotor in a manner where two permanent magnets face into three stator poles to accommodate a conventional three-phase lap wound motor/alternator or generator design. With the rising cost of rare earth permanent magnet materials, rotating machine designers are looking for solutions that will reduce the amount of rare earth material used without sacrificing power density. A conventional way of achieving this goal is to increase the number of stator teeth that produce torque over the 360 degrees (2 pi radians) they occupy.

One such machine topology is a single phase permanent magnet synchronous motor. A drawback with a single phase permanent magnet (PM) synchronous motor/generator is that all of the rotor and stator teeth come into and out of alignment at the same time or at angular intervals, producing their minimum and maximum torque (motor) or power (generator) values at the same time. Therefore, the average power (mechanical power/torque or electrical power) is lower than the desired optimal torque or power.

A concentrated winding topology means that each armature coil is wound around one single stator tooth in an electrical machine. Such winding configuration offers a large reduction of copper material compared with distributed winding topology where the coils are wound in laps enclosing several stator teeth. The concentrated winding topology thus provides the advantages of reduced total active volume and weight of the machine. The use of less coil material also offers a favorable reduction in copper loss and hence a high torque density motor design can be obtained. The coil overhang of the distributed winding topology produces unnecessary copper losses and extends the stator's axial dimension, which reduces torque density (or power density for given speed).

Flux linkage between rotor poles and the coils, i.e., winding factor, is an important design aspect. The maximum average torque output is directly proportional to the winding factor: a higher winding factor results in a higher output torque for a motor with a given frame size. Most of the three-phase machines have winding factors in the range 0.85 and 0.95. The distributed winding topology provides a winding factor equal to or nearly equal to the ideal value of one. Concentrated winding topology, on the other hand, typically has a lower winding factor lying within the range of 0.93 to 0.96. In theory, an ideal winding factor can be easily achieved even with a concentrated winding topology by choosing the same number of stator teeth as the number of rotor poles, but in practice this causes severe cogging.

Further, existing isolated phase IPM machines (for example, U.S. Pat. No. 7,067,948 B2) have high cogging torque, mechanical vibration and acoustic noise. A typical isolated phase stator with spaces separating phase groups, as shown in FIG. 1, comprises a rotor 105 comprising a plurality of rotor teeth 106 having alternating opposite permanent magnetic poles and a stator comprising a plurality of stator teeth 104. The stator teeth 104 are separated from one another by stator slots 108 accommodating concentrated armature coils 107 surrounding the teeth. The armature coils 107 are typically connected in a plurality of electrical phase groups. The coils 107 are arranged in two winding periodicities, each winding periodicity comprising three stator tooth sections separated by gaps 101, 102 and 103 that are wider than the regular stator slots 108 within each phase group.

US20120175994A1 discloses a magnetically isolated phase interior permanent magnet electrical rotating machine, each stator phase section having two or more stator teeth defining stator poles with winding slots separating the stator teeth and a concentrated phase winding wound about each stator tooth. All the stator teeth produce torque simultaneously and at different angular intervals, thereby producing a torque or power at a stator to rotor interface of 96% (48 stator teeth/50 rotor teeth) as opposed to 70% or less tier most conventional permanent magnet rotating machines, The shape of one isolation region may be different from that of another isolation region, i.e., the teeth are non-uniform. It is difficult to maintain the torque and power density of this isolated phase stator design. U.S. Pat. No. 4,647,802 discloses a design of reluctance motor where the stator has fewer teeth than the rotor. However, the concept has thus far been used in permanent magnet motors. U.S. Pat. No. 8,680,740 discloses a stator for a PM machine with the same number of stator teeth as rotor poles. The stator teeth are, however, not distributed with uniform distances and the design is expected to exhibit cogging problems.

The invention addresses some of the drawbacks of conventional interior permanent magnet machines, with further related advantages as set forth here.

### SUMMARY OF THE INVENTION

An isolated phase interior permanent magnet electrical machine with a rotor having a plurality of rotor teeth of alternating opposite permanent magnetic poles and a stator comprising a plurality of stator teeth is disclosed. The stator teeth are separated from one another by stator slots of uniform width configured to accommodate one or more concentrated armature coils surrounding the teeth. The teeth and the armature coils surrounding them are connected in a plurality of electrical phase groups. The number of stator teeth is one less than the number of rotor teeth, in one embodiment of the machine, the teeth are of uniform width, in another embodiment of the machine, teeth at either end of each phase group are wider than the teeth within the interior of each phase group.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 shows a typical isolated phase stator with spaces separating phase groups.

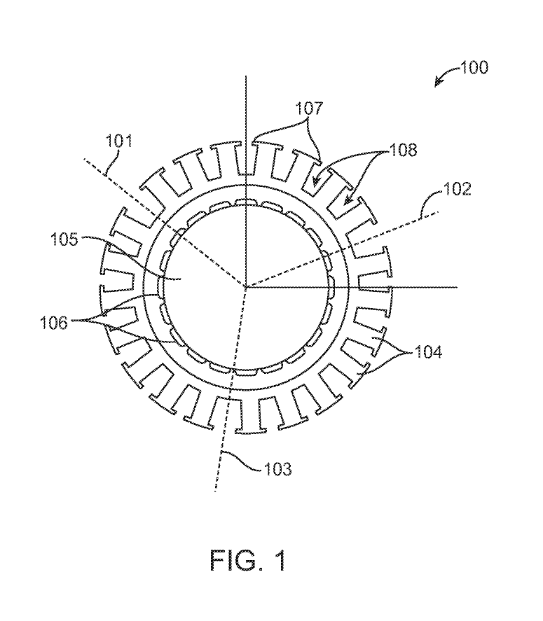

FIG. 2 shows an isolated phase stator with uniform teeth distributed around the stator circumference.

FIG. 3 shows an isolated phase stator with wide end teeth of each phase group of the isolated phase stator.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on,” Referring to the drawings, like numbers indicate like parts throughout the views. Additionally, a reference to the singular includes a reference to the plural unless otherwise stated or inconsistent with the disclosure herein,

The present invention relates to isolated phase interior permanent magnet machines comprising a stator phase section having stator teeth defining stator poles, a winding slot separating the stator teeth, and a phase winding wound about each stator tooth with reduced cogging torque, mechanical vibration and acoustic noise.

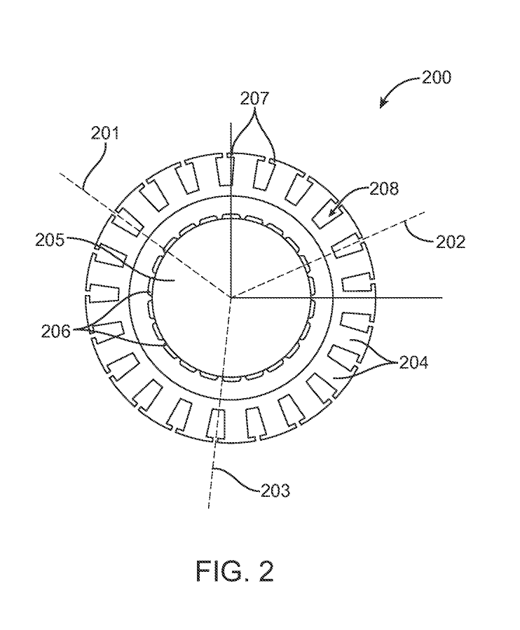

In one embodiment, the invention is an isolated phase interior permanent magnet electrical machine 200 as shown in FIG. 2. As shown in the figure, the machine 200 comprises a stator with plurality of stator teeth 204 and rotor 205 with a plurality of rotor poles 206, where the number of stator teeth 204 is one less than the number of rotor poles 206. In the embodiment shown in FIG, 2, the number of rotor poles 206 is 22 and the number of stator teeth 204 is 21, although the number could vary in other designs. Each of the stator teeth 204 has a portion of uniform width configured to accommodate one or more stator or armature coils 207 surrounding each stator tooth. In the embodiment shown in FIG. 2 the coils form three phase groups separated by slots 201, 202 and 203, although the number of coils could also be any other multiple of 3. The stator teeth 204 are all of the same width, and are distributed at uniform angular distances along the circumference of the stator as shown in FIG. 2, i.e., the angular distance between any two adjacent stator teeth 204 is the same. The stator teeth 204 are separated from one another by stator slots 208.

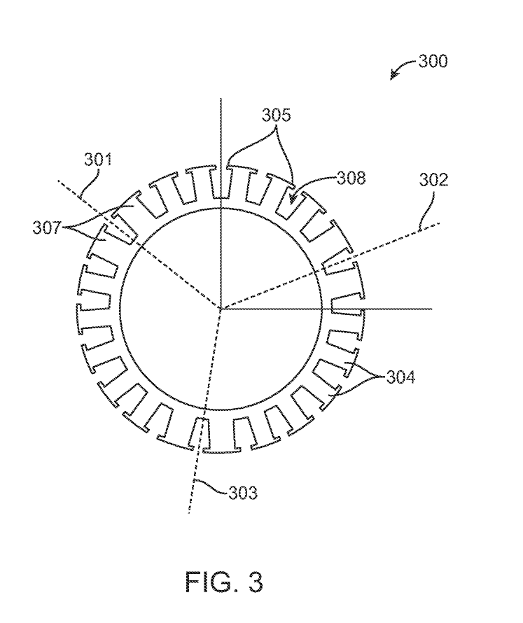

In another embodiment, an isolated phase interior permanent magnet electrical machine 300 is disclosed in FIG. 3. As shown in the figure,the machine 300 comprises a stator with a plurality of uniform stator teeth 304 arranged in three phase groups separated at slots 301, 302 and 303, at uniform angular intervals about the circumference of the stator. Each phase group is provided with end teeth 307 of different dimension adjacent to slots 301-303 on either side. Each stator tooth 304 has a portion of uniform width configured to accommodate one or more stator or armature coils 305 surrounding each uniform stator tooth 304 and end teeth 307. In one embodiment the uniform stator teeth 304 within each phase group are all of the same width, while end teeth 307 are wider than the interior teeth 304. The multiple radial slots 308 between the teeth are all of equal angular width.

The embodiments of the invention as disclosed above have many advantages over existing designs, as discussed further. In the embodiment of an isolated phase interior permanent magnet electrical machine shown in FIG, 2., the number of stator teeth 204 is one less than the number of rotor poles 206, which increases the size of stator slots 208, relative to existing machines, thereby providing greater space for windings, leading to simpler winding and increasing the power density. The uniform tooth width in the radial direction is also configured to provide a uniform flux density through the stator teeth 204 so that magnetic saturation occurs throughout the tooth at about the same excitation current and magnetic field flux. Since the angular spacing between the teeth is uniform, the flux transition of poles between phases is smooth and balances the tangential forces between rotor poles 206 and stator teeth 204 edges without noticeably reducing the generated output. This smooth transition between phases has the effect of reducing cogging torque, mechanical vibrations, and acoustic noise.

In the embodiment of an isolated phase interior permanent magnet electrical machine as shown in FIG. 3, each stator phase section separated by slots 301, 302 and 303 comprises wider end teeth 307 on either side, while the stator slots 308 are of equal angular spacing. Motor torque ripple is attenuated by providing end teeth 307 of greater width for a given phase group. This alternative design also provides smooth flux transition of poles between phases without noticeably reducing the generated output thereby reducing the tangential forces that cause cogging torque, mechanical vibrations, and acoustic noise.

In the above embodiments disclosed with reference to FIG. 2, and FIG. 3, a concentrated winding topology means that each armature coil is wound around one single stator tooth in the IPM machine. Such winding configuration offers a large reduction of copper material compared with distributed winding topology where the coils are wound in laps enclosing several stator teeth. The coil overhang of the distributed winding topology produces unnecessary copper losses and extends the stator's axial dimension, which reduces torque density (or power density for given speed). The concentrated winding topology thus provides the advantages of reduced total active volume and weight of the machine.

While the invention has been disclosed with reference to certain embodiments, it will be understood by those skilled in the art that various changes may be made and equivalents may be substituted without departing from the scope of the invention. In addition, many modifications may be made to adapt to a particular situation or material the teachings of the invention without departing from its scope as further explained in the following examples, which however, are not to be construed to limit the scope of the invention as delineated by the claims.

What is claimed is:

1. An isolated phase interior permanent magnet electrical machine comprising:
a rotor comprising a plurality of rotor teeth having alternating opposite permanent magnetic poles; and,
a stator comprising a plurality of stator teeth, the stator teeth having a uniform width in the radial direction configured to accommodate one or more concentrated armature coils surrounding the stator teeth and separated from one another by stator slots of uniform angular spacing, wherein the armature coils are connected in a plurality of electrical phase groups; and
wherein, the number of stator teeth is one less than the number of rotor teeth.

2. The machine of claim 1, wherein the stator teeth are of same width.

3. The machine of claim 1, wherein the stator teeth at either end of each phase group are wider than the stator teeth within the interior of each phase group.
